(19) United States
(12) Patent Application Publication
(10) Pub. No.: US 2011/0063185 A1
(43) Pub. Date: Mar. 17, 2011

(54) DIELECTRIC LOADED SLEEVE DIPOLE ANTENNA

(75) Inventors: Jesse Lin, Carol Stream, IL (US); Kevin Le, Portola Hills, CA (US); Miroslav Parvanov, Naperville, IL (US)

(73) Assignee: PC-Tel, Inc., Bloomingdale, IL (US)

(21) Appl. No.: 12/880,366

(22) Filed: Sep. 13, 2010

Related U.S. Application Data
(60) Provisional application No. 61/243,360, filed on Sep. 17, 2009.

(51) Int. Cl. H01Q 1/42; H01Q 9/32

(52) U.S. Cl. 343/872; 343/900

(57) ABSTRACT

An antenna operating at a frequency f is provided. The antenna includes an elongated shaft having a first end, a second end, a first member, a second member, and a third member, and an antenna sleeve surrounding at least a portion of the second member of the elongated shaft. The first, second, and third members are contiguous with each other, and the antenna sleeve is loaded with a dielectric material to shorten a length of the second member of the elongated shaft.

### CROSS-REFERENCE TO RELATED APPLICATIONS

This application claims priority to and hereby incorporates by reference U.S. Provisional Patent Application No. 61/243,360 filed Sep. 17, 2009 and titled “Dielectric Loaded Sleeve Dipole Antenna.”

### FIELD OF INVENTION

The present invention relates generally to dipole antennas. More particularly, the present invention relates to dielectric loaded sleeve dipole antennas.

### BACKGROUND

Dipole antennas are known in the art. Dipole antennas can include an inner conductor surrounded by a coaxial cable braid and, in many applications, can be housed in a radome. Thus, the mechanical characteristics of the antenna are limited by the mechanical characteristics of the radome in which the antenna is housed.

FIGS. 1A and 1B are side views of a radome 100 and antenna 200, respectively, known in the art. As seen in FIG. 1A, the radome 100 can include a hollow elongated shaft 110 having a first end 112 and a second end 114. The shaft 110 can include contiguous first, second, and third members 120, 130, and 140, respectively, which include length, width, circumference, and diameter measurements suitable for the environment in which the radome is employed. For example, the radome 100 can include mechanical characteristics to be compatible with an antenna operating at a frequency of 800 MHz.

The radome seen in FIG. 1A can have a total length of RL. For example, RL can be between approximately 10.0″ and 11.0″ and in some embodiments can be approximately 10.5″. The first member 120 can have a length of RL1 and can include vertical ribbing 122 at a bottom end thereof to reinforce the first member 120. For example, RL1 can be between approximately 4.0″ and 5.0″ and in some embodiments can be approximately 4.7″. The second and third members 130 and 140, respectively, can have a total length of RL2. For example, RL2 can be between approximately 5.0″ and 6.0″ and in some embodiments can be approximately 5.8″. The third member 140 can have a diameter that tapers from the larger diameter of the second member 130 to the smaller diameter of the second end 114 of the shaft 110.

To enhance flexibility of the radome 100, a bottom end of the second member 130 can include an accordion-like ribbing 132 extending around an outer circumference of the shaft 100. The accordion-like ribbing 132 can be useful when the radome 100 and antenna 200 are employed in an environment with a lot of vibration, for example, on a tractor. The radome 100 can be made of any polymer as would be known by those of skill in the art. Preferably, the radome 100 can be made of a flexible material to further enhance the flexibility of the radome 100.

As seen in FIG. 1B, the antenna 200 can include an elongated shaft 210 with an inner cable conductor surrounded by a coaxial cable braid and first and second ends 212 and 214, respectively, at distal ends of the shaft 210. The shaft 210 can include contiguous first, second, and third members 220, 230, and 240, respectively, which include length, width, circumference, and diameter measurements that are compatible with the radome 100 shown in FIG. 1A. For example, the diameter of the antenna 200 at the second end 212 thereof can be AD, which can be between approximately 0.3″ and 0.4″ and in some embodiments can be approximately 0.32″.

The first member 220 of the antenna 100 can have a length of AL1 and can include mechanical and electrical features for connecting to an antenna base or mount as would be known by those of skill in the art. For example, AL1 can be between 0.5″ and 1.5″ and in some embodiments can be approximately 1.0″.

The second member 230 can have a length of AL2 and can include a sleeve 232 encasing at least a portion of the second member 230. For example, AL2 can be between 3.0″ and 4.0″ and in some embodiments can be approximately 3.7″. The antenna sleeve 232 can facilitate the removal of feeder radiation from the antenna 200.

The third member 240 can have a length of AL3 and can have a diameter that is smaller than the diameter of the second member 230. For example, AL3 can be between approximately 3.0″ and 4.0″ and in some embodiments can be approximately 3.7″. The smaller diameter of the third member 240 can enable the antenna 200 to fit within the dimensions of the radome 100 and to be flexible relative to the accordion-like ribbing 132 of the second member 130 of the radome 100.

The length of the antenna can be a function of the frequency of the antenna. That is, the length of the antenna 200 as a whole can be the sum of AL1+AL2+AL2 or λₒ/2 where λₒ is the wavelength of the antenna 200 in free space. λₒ can be defined as:

λₒ=cₒ/(f√∈ᵣ)

where cₒ is the speed of light, f is the antenna frequency, and ∈ᵣ is the relative dielectric constant.

The antenna 200 is in free space. Therefore, the relative dielectric constant ∈ᵣ is 1, and λₒ can be defined as:

λₒ=cₒ/(f√1)=cₒ/f

The total length of the first and second members 220 and 230, respectively, (including the antenna sleeve 232) can be the sum of AL1+AL2 or λₒ/4. The length of the third member 240 of the antenna 200 can be AL3 or λₒ/4.

The sum of AL1+AL2 or λₒ/4 can be approximately equal to RL1. Thus, the first and second members 220 and 230, respectively, of the antenna 200 can fit within the radome 100 substantially below the accordion-like ribbing 132 of the second member 130 of the radome.

In some applications or environments, it may be desirable to employ a dipole antenna operating at a frequency lower than 800 MHz. However, as explained above, the length of the antenna is a function of the frequency of the antenna. Thus, changing the frequency of the antenna also changes the length and mechanical characteristics of the antenna. As also explained above, the mechanical characteristics and dimensions of the antenna are limited by the mechanical characteristics of the radome.

There is thus a continuing, ongoing need for a dipole antenna in which desired electrical characteristics are achieved within given mechanical parameters. Preferably, such a dipole antenna operates at a frequency lower than 800 MHz and fits suitably within a radome having fixed mechanical characteristics.

### SUMMARY OF THE INVENTION

According to one embodiment of the present invention, an antenna operating at a frequency f is provided. The antenna can include an elongated shaft having a first end, a second end, a first member, a second member, and a third member, and an antenna sleeve surrounding at least a portion of the second member of the elongated shaft. The first, second, and third members can be contiguous with each other, and the antenna sleeve can be loaded with a dielectric material to shorten a length of the second member of the elongated shaft.

The antenna shaft can be compatible with a radome housing, and the frequency f of the antenna can be 400 MHz.

The elongated shaft can include an inner cable conductor surrounded by a coaxial cable braid. The first member of the elongated shaft can include at least one mechanical or electrical feature for connecting to at least one of an antenna base and an antenna mount. The antenna sleeve can remove feeder radiation emitted from the antenna. A diameter of the third member of the elongated shaft can be smaller than a diameter of the second member of the elongated shaft.

The antenna sleeve can surround substantially all of the second member of the elongated shaft. The antenna sleeve can include the dielectric material surrounded by an antenna choke. A relative dielectric constant of the dielectric material can be between 8 and 12, and the relative dielectric constant can be 10.

The sum of a length of the first member and a length of the second member of the elongated shaft can be λ_{g}/4, wherein λ_{g}/4=cₒ/(f√∈ᵣ), where cₒ is the speed of light, f is the frequency of the antenna, and ∈ᵣ is a relative dielectric constant of the dielectric material. The length of the second member of the elongated shaft can be between approximately 2.0 inches and approximately 3.0 inches, and the length of the second member of the elongated shaft can be approximately 2.2 inches.

According to another embodiment of the present invention, an apparatus is provided including a radome and an antenna. The radome can include a hollow elongated shaft having a first end, a second end, a first member, a second member, and a third member. A bottom end of the second member of the radome can include accordion-like ribbing disposed on an outer circumference thereof, and a diameter of the third member of the radome can be smaller than a diameter of the second member of the radome.

The antenna can operate at a frequency f and can be housed within the radome. The antenna can include an elongated shaft having a first end, a second end, a first member, a second member, and a third member, and an antenna sleeve surrounding at least a portion of the second member of the antenna. The first, second, and third members of the antenna can be contiguous with each other, and the antenna sleeve can be loaded with a dielectric material to shorten a length of the second member of the antenna. The sum of a length of the first member and a length of the second member of the antenna can be less than or equal to a length of the first member of the radome.

The first member and the second member of the antenna can be housed within the radome substantially below the accordion-like ribbing of the radome. The sum of the length of the first member and the length of the second member of the antenna can be λ_{g}/4, wherein λ_{g}/4=cₒ/(f√∈ᵣ), where cₒ is the speed of light, f is the frequency of the antenna, and ∈ᵣ is a relative dielectric constant of the dielectric material. The length of the second member of the elongated shaft can be between approximately 2.0 inches and approximately 3.0 inches, and the length of the second member of the elongated shaft can be approximately 2.2 inches.

In accordance with another embodiment of the present invention, a method of shortening the length of an antenna operating at a frequency f is provided. The method includes providing an antenna with an elongated shaft having a first end, a second end, a first member, a second member, and a third member, surrounding at least a portion of the second member of the elongated shaft with an antenna sleeve, and loading a dielectric material into the antenna sleeve.

### BRIEF DESCRIPTION OF THE DRAWINGS

FIG. 1A is a side view of a radome having fixed mechanical characteristics known in the art;

FIG. 1B is a side view of a dipole antenna operating at 800 MHz known in the art;

FIG. 2 is a side view of a dipole antenna operating at 400 MHz;

FIG. 3A is a side view of a dipole antenna operating at 400 MHz in accordance with the present invention; and

FIG. 3B is a cross-sectional view of the antenna of FIG. 3A in accordance with the present invention.

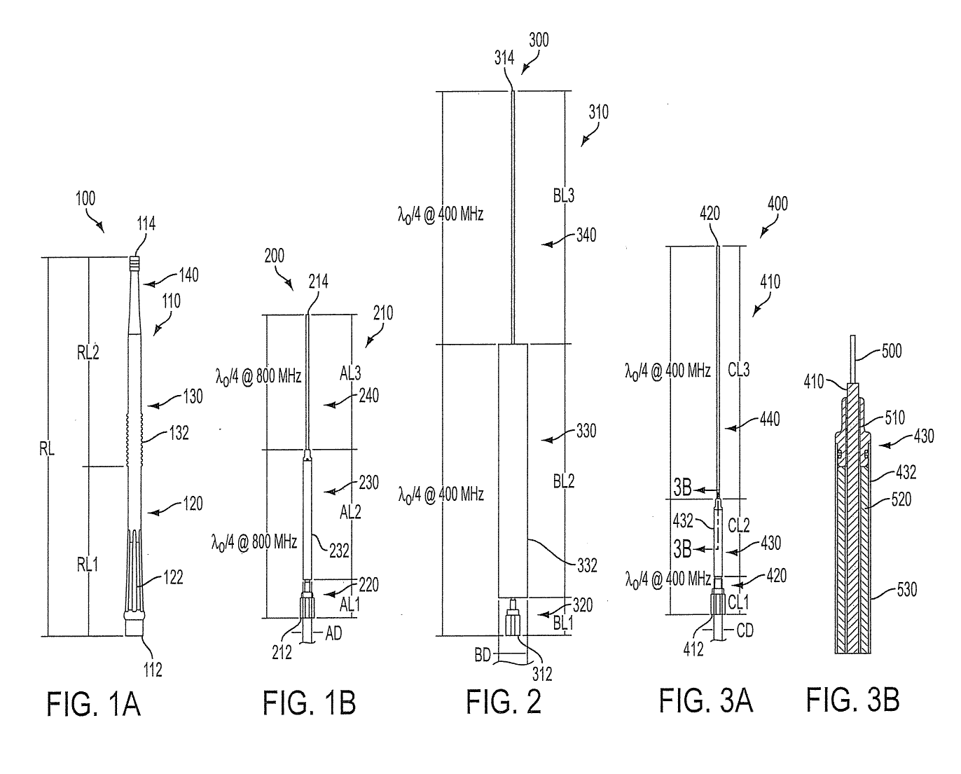

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include a dipole antenna in which desired electrical characteristics are achieved within given mechanical parameters. Preferably, such a dipole antenna operates at a frequency lower than 800 MHz and fits suitably within a radome having fixed mechanical characteristics.

In accordance with the present invention, electrical parameters of a dipole antenna can be altered to fit the antenna within given mechanical properties, i.e. the dimensions of a radome. In embodiments of the present invention, the antenna can operate at 400 MHz.

It is to be understood that an antenna in accordance with the present invention can operate at a frequency as would be desired that is less than 800 MHz but not lower than 400 MHz. An antenna in accordance with the present invention is shown and described herein operating at a frequency of 400 MHz. However, it is to be understood that an antenna in accordance with the present invention is not limited to operating at 400 MHz.

FIG. 2 is a side view of a dipole antenna 300 operating at 400 MHz. The antenna 300 can include an elongated shaft 310 with an inner cable conductor surrounded by a coaxial cable braid and first and second ends 312 and 314, respectively, at distal ends of the shaft 310. The shaft 310 can include contiguous first, second, and third members 320, 330, and 340, respectively.

The first member 320 of the antenna 300 can have a length of BL1 and can include mechanical and electrical features for connecting to an antenna base or mount as would be known by those of skill in the art. The second member 330 of the antenna 300 can have a length BL2 and can include a sleeve 332 encasing at least a portion of the second member 330. The sleeve 332 can facilitate the removal of feeder radiation from the antenna 300. The third member 340 of the antenna 300 can have a length BL3 and can have a diameter that is smaller than the diameter of the second member 330.

As explained above, the length of the antenna can be a function of the frequency of the antenna. That is, the length of the antenna 300 as a whole can be the sum of BL1+BL2+BL3 or λₒ/2 where λₒ is the wavelength of the antenna 100 in free space. λₒ can be defined as:

λₒ=cₒ/(f√∈ᵣ)

where cₒ is the speed of light, f is the antenna frequency, and ∈ᵣ is the relative dielectric constant.

The antenna 300 is in free space. Therefore, the relative dielectric constant ∈ᵣ is 1, and λₒ can be defined as:

λₒ=cₒ/(f√∈1)=cₒ/f

The total length of the first and second members 320 and 330, respectively, can be the sum of BL1+BL2 or λₒ/4, and the length of the third member 340 of the antenna 200 can be BL3 or λₒ/4.

Because the length of the antenna 300 is a function of the frequency of the antenna, BL1 can be between approximately 0.5″ and 1.5″ and in some embodiments can be approximately 1.0″. BL2 can be between approximately 6.5″ and 7.5″ and in some embodiments can be approximately 7.0″. BL3 can be between approximately 6.5″ and 7.5″ and in some embodiments can be approximately 7.0″. In accordance with these lengths, the diameter of the antenna 300 at the second end 312 thereof can be BD, which can be between 0.8″ and 0.9″ and in some embodiments can be approximately 0.84″.

When the frequency of the antenna 300 is lowered to 400 MHz, the length of the antenna 300 is increased as a function of the frequency. Thus, the length of the antenna 300 as a whole (the sum of BL1+BL2+BL3 or λₒ/2) is not compatible with the length RL of the radome 100, and the diameter BD of the second end 312 of the antenna 300 is not compatible with the diameter of the second end 112 of the radome 100. Further, the length of the first and second members 320 and 330, respectively, (BL1+BL2 or λₒ/4) is not compatible with the length of the first member 120 of the radome 100. Thus, the antenna sleeve 332 of the antenna 300 does not fit substantially below the accordion-like ribbing 132 of the radome 100.

In accordance with the present invention, the electrical parameters of an antenna operating at 400 MHz can be altered to fit within the fixed mechanical characteristics of the radome 100. For example, a sleeve of the antenna can be shortened to accommodate the accordion-like ribbing 132 of the radome 100, and the sleeve can be loaded with a dielectric material.

FIG. 3A is a side view of a dipole antenna operating at 400 MHz in accordance with the present invention, and FIG. 3B is a cross-sectional view of the antenna of FIG. 3A. The antenna 400 in accordance with the present invention can include an elongated shaft 410 with an inner cable conductor surrounded by a coaxial cable braid and first and second ends 412 and 414, respectively, at distal ends of the shaft 410. The shaft 410 can include contiguous first, second, and third members 420, 430, and 440, respectively.

The first member 420 of the antenna 400 can have a length of CL1 and can include mechanical and electrical features for connecting to an antenna base or mount as would be known by those of skill in the art. The second member 430 of the antenna 400 can have a length CL2 and can include a sleeve 432 encasing at least a portion of the second member 430. The sleeve 432, which is described in more detail herein, can facilitate the removal of feeder radiation from the antenna 400. The third member 440 of the antenna 400 can have a length CL3 and can have a diameter that is smaller than the diameter of the second member 430.

As explained above with reference to FIG. 2, a 400 MHz antenna 300 is too long and wide and thus is not compatible with the fixed mechanical characteristics of the radome 100. To shorten the length of the antenna while still operating at a frequency of 400 MHz, the electrical parameters of the antenna can altered. For example, in accordance with the present invention, the sleeve 432 of the antenna 300 can be shortened and loaded with a dielectric.

As best seen in FIG. 3B, the second member 430 of the shaft 410 of the antenna 400 can include an inner cable conductor 500 surrounded by a coaxial cable braid 510. The coaxial cable braid 510 can be surrounded by the antenna sleeve 432, which can include a dielectric material 520 surrounded by an antenna choke 530.

In embodiments of the present invention, the relative dielectric constant ∈ᵣ of the dielectric material 520 can be between 8 and 12. In some embodiments, the relative dielectric constant ∈ᵣ of the dielectric material can be 10.

As explained above, the length of the antenna can be a function of the frequency of the antenna. That is, the length of the antenna 400 as a whole can be the sum of CL1+CL2+CL3 or λ_{g}/2 where λ_{g} is the wavelength of the antenna 400 when the antenna sleeve 432 is loaded with the dielectric material 520. λ_{g} can be defined as:

λ_{g}=cₒ/(f√∈ᵣ)

where cₒ is the speed of light, f is the antenna frequency, and ∈ᵣ is the relative dielectric constant of the dielectric material 520 loaded in the antenna sleeve 332.

In embodiments where the relative dielectric constant ∈ᵣ of the dielectric material 520 is 10, λ_{g} can be defined as:

λ_{g}=cₒ/(f√10)

The total length of the first and second members 420 and 430, respectively, of the antenna 400 can be the sum of CL1+CL2 or λ_{g}/4, and the length of the third member 440 of the antenna 400 can be CL3 or λₒ/4 because the third member 440 is not loaded with a dielectric material.

Because the length of the antenna 400 is a function of the frequency of the antenna 400 and because the antenna sleeve 432 is loaded with the dielectric material 520, CL1 can be between approximately 0.5″ and 1.5″ and in some embodiments can be approximately 1.0″. CL2 can be between approximately 2.0″ and 3.0″ and in some embodiments can be approximately 2.2″. CL3 can be between approximately 6.5″ and 7.5″ and in some embodiments can be approximately 7.0″. In accordance with these lengths, the diameter of the antenna 400 at the second end 412 thereof can be CD, which can be between approximately 0.3″ and 0.4″ and in some embodiments can be approximately 0.32″.

In accordance with the above, the length of the antenna 400 as a whole (the sum of CL1+CL2+CL3 or λ_{g}/2) can be compatible with the length RL of the radome 100 and fit within the radome 100. Further, the length of the first and second members 420 and 430, respectively, (the sum of CL1+CL2 or λ_{g}/4) can be compatible with the length of the first member 120 of the radome. That is, the sum of CL1+CL2 or λ_{g}/4 can be less than or equal to RL1. Thus, the first and second members 420 and 430, respectively, of the antenna 400 can fit within the radome 100 substantially below the accordion-like ribbing 132 of the second member 130 of the radome.

In accordance with the length of the antenna 400, the diameter CD of the second end 412 of the antenna 412 can be less than the diameter of the second end 112 of the radome 112. Accordingly, the diameter of the antenna 400 can also be compatible with the diameter of the radome 100.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the sprit and scope of the claims.

What is claimed is:

1. An antenna operating at a frequency f, the antenna comprising:
an elongated shaft having a first end, a second end, a first member, a second member, and a third member; and
an antenna sleeve surrounding at least a portion of the second member of the elongated shaft,
wherein the first, second, and third members are contiguous with each other, and the antenna sleeve is loaded with a dielectric material to shorten a length of the second member of the elongated shaft.

2. The antenna of claim 1, wherein the antenna shaft is compatible with a radome housing.

3. The antenna of claim 1 wherein the frequency f is 400 MHz.

4. The antenna of claim 1 wherein the elongated shaft includes an inner cable conductor surrounded by a coaxial cable braid.

5. The antenna of claim 1 wherein the first member of the elongated shaft includes at least one mechanical or electrical feature for connecting to at least one of an antenna base and an antenna mount.

6. The antenna of claim 1 wherein the antenna sleeve removes feeder radiation emitted from the antenna.

7. The antenna of claim 1 wherein a diameter of the third member of the elongated shaft is smaller than a diameter of the second member of the elongated shaft.

8. The antenna of claim 1 wherein the antenna sleeve surrounds substantially all of the second member of the elongated shaft.

9. The antenna of claim 1 wherein the antenna sleeve includes the dielectric material surrounded by an antenna choke.

10. The antenna of claim 1 wherein a relative dielectric constant of the dielectric material is between 8 and 12.

11. The antenna of claim 1 wherein the relative dielectric constant is 10.

12. The antenna of claim 1 wherein the sum of a length of the first member and a length of the second member of the elongated shaft is λ_{g}/4, wherein λ_{g}/4=cₒ/(f√∈ᵣ), where cₒ is the speed of light, f is the frequency of the antenna, and ∈ᵣ is a relative dielectric constant of the dielectric material.

13. The antenna of claim 12 wherein the length of the second member of the elongated shaft is between approximately 2.0 inches and approximately 3.0 inches.

14. The antenna of claim 13 wherein the length of the second member of the elongated shaft is approximately 2.2 inches.

15. An apparatus comprising:
a radome including:
a hollow elongated shaft having a first end, a second end, a first member, a second member, and a third member,
wherein a bottom end of the second member of the radome includes accordion-like ribbing disposed on an outer circumference thereof, and
wherein a diameter of the third member of the radome is smaller than a diameter of the second member of the radome; and
an antenna operating at a frequency f and housed within the radome, the antenna including:
an elongated shaft having a first end, a second end, a first member, a second member, and a third member; and
an antenna sleeve surrounding at least a portion of the second member of the antenna,
wherein the first, second, and third members of the antenna are contiguous with each other, and the antenna sleeve is loaded with a dielectric material to shorten a length of the second member of the antenna, and
wherein the sum of a length of the first member and a length of the second member of the antenna is less than or equal to a length of the first member of the radome.

16. The apparatus of claim 15 wherein the first member and the second member of the antenna are housed within the radome substantially below the accordion-like ribbing of the radome.

17. The antenna of claim 15 wherein the sum of the length of the first member and the length of the second member of the antenna is λ_{g}/4, wherein λ_{g}/4=cₒ/(f√∈ᵣ), where cₒ is the speed of light, f is the frequency of the antenna, and ∈ᵣ is a relative dielectric constant of the dielectric material.

18. The antenna of claim 17 wherein the length of the second member of the elongated shaft is between approximately 2.0 inches and approximately 3.0 inches.

19. The antenna of claim 18 wherein the length of the second member of the elongated shaft is approximately 2.2 inches.

20. A method of shortening the length of an antenna operating at a frequency f comprising:
providing an antenna with an elongated shaft having a first end, a second end, a first member, a second member, and a third member;
surrounding at least a portion of the second member of the elongated shaft with an antenna sleeve; and
loading a dielectric material into the antenna sleeve.
